(19) United States
(12) Patent Application Publication
(10) Pub. No.: US 2026/0166875 A1
(43) Pub. Date: Jun. 18, 2026

(54) LIQUID DISCHARGE HEAD, HEAD UNIT, AND LIQUID DISCHARGE APPARATUS

(71) Applicant: Toshimichi ODAKA, Kanagawa (JP)

(72) Inventor: Toshimichi ODAKA, Kanagawa (JP)

(21) Appl. No.: 19/411,387

(22) Filed: Dec. 8, 2025

(30) Foreign Application Priority Data
Dec. 18, 2024 (JP) 2024-221458

(51) Int. Cl. B41J 2/045; B41J 2/14; B41J 2/17

(52) U.S. Cl. CPC B41J 2/04525; B41J 2/04581; B41J 2/14233; B41J 2/1433; B41J 2/1707; B41J 2002/14419

(57) ABSTRACT

A liquid discharge head includes: a nozzle plate having multiple nozzles; a liquid chamber member over the nozzle plate, the liquid chamber member having multiple individual chambers individually communicating with the multiple nozzles of the nozzle plate; a diaphragm over the liquid chamber member, the diaphragm forming a portion of a wall face of the multiple individual chambers; a piezoelectric element over the diaphragm, the piezoelectric element to deform the diaphragm to discharge a liquid in the multiple individual chambers from the multiple nozzles in a discharge direction; a base over the piezoelectric element, the base supporting the piezoelectric element; a common channel member over the diaphragm, the common channel member having a common channel communicating with each of the multiple individual chambers; and a damper over the common channel member, and the damper forming a portion of a wall face of the common channel.

### CROSS-REFERENCE TO RELATED APPLICATIONS

This patent application is based on and claims priority pursuant to 35 U.S.C. § 119(a) to Japanese Patent Application No. 2024-221458, filed on Dec. 18, 2024, in the Japan Patent Office, the entire disclosure of which is hereby incorporated by reference herein.

### BACKGROUND

### Technical Field

The present embodiment relates to a liquid discharge head, a head unit, and a liquid discharge apparatus.

### Related Art

As an example of a liquid discharge apparatus that discharges liquid, there is an inkjet image forming apparatus that discharges liquid ink onto a sheet, such as paper, to form an image.

In this type of image forming apparatus, a liquid discharge head that discharges liquid from a nozzle by pressurizing liquid (ink) in a liquid chamber using an actuator, such as a piezoelectric element, is mounted.

### SUMMARY

The present disclosure described herein provides a liquid discharge head includes: a nozzle plate having multiple nozzles; a liquid chamber member over the nozzle plate, the liquid chamber member having multiple individual chambers individually communicating with the multiple nozzles of the nozzle plate; a diaphragm over the liquid chamber member, the diaphragm forming a portion of a wall face of the multiple individual chambers; a piezoelectric element over the diaphragm, the piezoelectric element to deform the diaphragm to discharge a liquid in the multiple individual chambers from the multiple nozzles in a discharge direction; a base over the piezoelectric element, the base supporting the piezoelectric element; a common channel member over the diaphragm, the common channel member having a common channel communicating with each of the multiple individual chambers; and a damper over the common channel member, the damper forming a portion of a wall face of the common channel, and the damper is farther from the nozzle plate than the base in the discharge direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view illustrating an overall configuration of an inkjet image forming apparatus according to a first embodiment;

FIG. 2 is a control block diagram of the image forming apparatus according to the first embodiment;

FIG. 3 is an external perspective view of a liquid discharge head according to the first embodiment;

FIG. 4 is a cross-sectional view of the liquid discharge head according to the first embodiment taken along a Y direction in FIG. 1;

FIG. 5 is a cross-sectional view illustrating a configuration of a characteristic portion of the liquid discharge head according to the first embodiment;

FIG. 6 is a cross-sectional view of the liquid discharge head according to a second embodiment;

FIG. 7 is a cross-sectional view of the liquid discharge head according to the second embodiment taken along a line A-A in FIG. 6;

FIG. 8 is a cross-sectional view of a liquid discharge head according to a third embodiment;

FIG. 9 is a cross-sectional view of the liquid discharge head according to the third embodiment taken along a line B-B in FIG. 8;

FIG. 10 is a plan view illustrating a configuration of a line-type head unit;

FIG. 11 is a plan view illustrating a configuration of a serial-type head unit;

FIG. 12 is a schematic view illustrating an overall configuration of an electrode manufacturing apparatus to which the present embodiment can be applied; and

FIG. 13 is a cross-sectional view of a liquid discharge head according to a comparative example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected, and it is to be understood that each specific element includes all technical equivalents that have a similar function, operate similarly, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, the present embodiment will be described with reference to the accompanying drawings. In the drawings for describing the present embodiment, components such as members and constituent parts having the same function or shape are denoted by the same reference numerals as long as they can be discriminated, and the description thereof will be omitted after being once described.

### Overall Configuration of Image Forming Apparatus

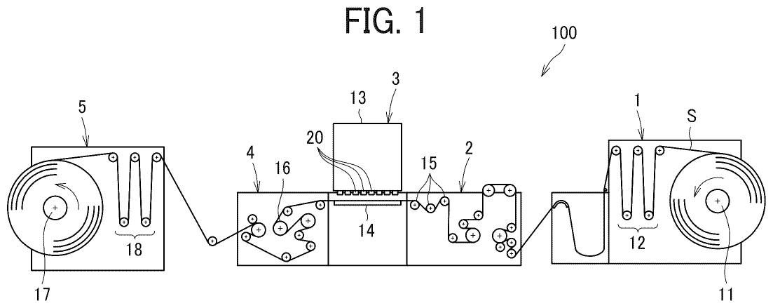

First, with reference to FIG. 1, a description will be given of an inkjet image forming apparatus, which is an example of a liquid discharge apparatus to which the present embodiment is to be applied.

FIG. 1 is a schematic view illustrating an overall configuration of an inkjet image forming apparatus 100 according to a first embodiment.

As illustrated in FIG. 1, the image forming apparatus 100 according to the first embodiment includes a sheet feeding unit 1, a sheet conveying unit 2, an image forming unit 3, a drying unit 4, and a sheet collection unit 5.

The sheet feeding unit 1 includes a feed roller 11 and a tension adjusting mechanism 12. The feed roller 11 feeds a sheet S. The tension adjusting mechanism 12 adjusts the tension of the fed sheet S. The sheet S that is large in length is wound around the feed roller 11 in a roll shape. When the feed roller 11 rotates, the sheet S is unwound and fed from the feed roller 11. The tension adjusting mechanism 12 is a mechanism that adjusts the tension of the sheet S to feed the sheet S with a constant tension. Specifically, the tension adjusting mechanism 12 includes multiple support rollers on which the sheet S is stretched. The tension adjusting mechanism 12 adjusts the tension of the sheet S by changing the interval between the support rollers. As a result, the sheet S is supplied with constant tension.

The sheet conveying unit 2 includes multiple conveyance rollers 15 that convey the sheet S fed from the sheet feeding unit 1 to the image forming unit 3. The conveyance roller 15 is an example of a conveyance means that conveys the sheet S. As the conveyance means, a conveyance belt, or the like, may be used in addition to the conveyance roller 15. The sheet S is conveyed to the image forming unit 3 by the multiple conveyance rollers 15 rotating in a state where the sheet S is stretched between the conveyance rollers 15.

The image forming unit 3 includes a head unit 13 on which multiple liquid discharge heads 20 are mounted.

In the image forming unit 3, a conveyance guide 14 that guides the sheet S to be conveyed is disposed at a position facing the head unit 13. When the sheet S is conveyed to the image forming unit 3, the sheet S is guided by the conveyance guide 14, and ink is discharged from the liquid discharge heads 20 onto the sheet S to form an image on the sheet S.

The drying unit 4 includes a heating roller 16 that heats the sheet S. The heating roller 16 is a cylindrical heating member having a heating source, such as a halogen heater, therein. After an image is formed on the sheet S, when the sheet S is conveyed to the drying unit 4, the sheet S is heated by coming into contact with the outer peripheral surface of the heating roller 16. As a result, a liquid component contained in the ink on the sheet S is evaporated, and the sheet S is dried. As the heating means that heats the sheet S, non-contact heating means, such as a hot air generation device that blows hot air to the sheet S, may be used in addition to contact-type heating means, such as the heating roller 16.

The sheet collection unit 5 includes a collection roller 17 and a tension adjusting mechanism 18. The collection roller 17 winds and collects the sheet S. The tension adjusting mechanism 18 adjusts the tension of the sheet S. When the sheet S is conveyed to the sheet collection unit 5, the sheet S is wound into a roll shape and collected by the collection roller 17 that is rotating. Similarly to the tension adjusting mechanism 12 of the sheet feeding unit 1, the tension adjusting mechanism 18 includes multiple support rollers on which the sheet S is stretched, and the tension of the sheet S is adjusted by changing the interval between the support rollers. As a result, the sheet S is wound with constant tension by the collection roller 17 and collected.

### Control Configuration of Image Forming Apparatus

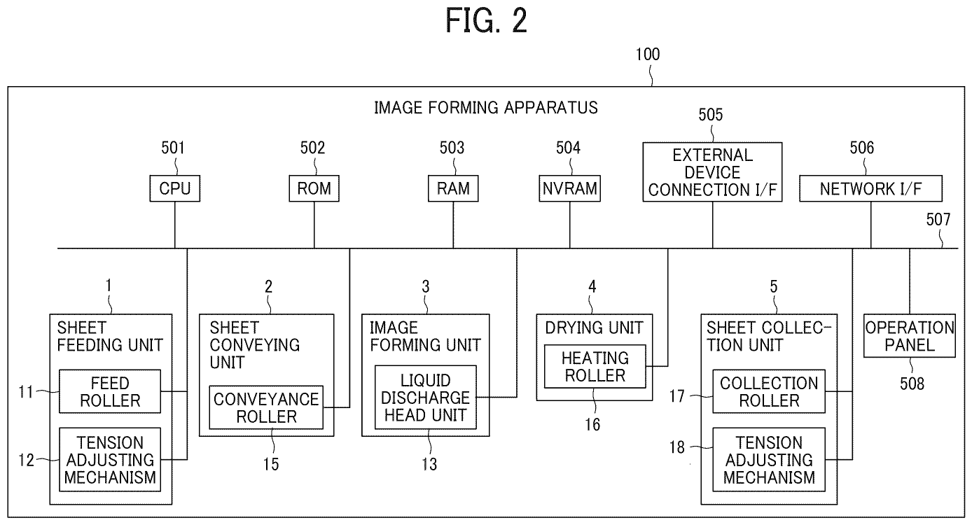

FIG. 2 is a control block diagram of the image forming apparatus 100 according to the first embodiment.

As illustrated in FIG. 2, the image forming apparatus 100 according to the first embodiment includes a central processing unit (CPU) 501, a read only memory (ROM) 502, a random access memory (RAM) 503, a non-volatile random access memory (NVRAM) 504, an external device connection interface (I/F) 505, a network I/F 506, a bus line 507 and an operation panel 508.

The CPU 501 is an arithmetic unit that controls the entire operation of the image forming apparatus 100. Specifically, the CPU 501 controls the operation of the head unit 13, rotation speeds of the feed roller 11, the collection roller 17, and the conveyance roller 15, the temperature of the heating roller 16, tension adjusting operation of the tension adjusting mechanisms 12 and 18, and the like. The ROM 502 is a read-only non-volatile storage medium that stores programs, such as an initial program loader (IPL), to be used for driving the CPU 501. The RAM 503 is a volatile storage medium that allows data to be read and written at high speed. The CPU 501 uses the RAM 503 as a working area for data processing. The NVRAM 504 is a non-volatile storage medium that allows reading and writing of data, and stores various types of data, such as a setting value and a program necessary for controlling each unit of the image forming apparatus 100. A program stored in the ROM 502 is read into the RAM 503. According to the program loaded into the RAM 503, the CPU 501 performs an arithmetic operation to control each unit of the image forming apparatus 100. In this event, the CPU 501 uses a setting value, or the like, stored in the NVRAM 504.

The external device connection I/F 505 is connected to a personal computer (PC) by a universal serial bus (USB) cable, or the like, and performs data communication with the PC with respect to a control signal and data on an image to be printed. The network I/F 506 is an interface for data communication using a communication network such as the Internet. The bus line 507 is, for example, an address bus and a data bus for electrically connecting the components, such as the CPU 501.

The operation panel 508 is a touch-panel input unit that displays a current setting value, a selection screen, and the like, and receives an input from an operator. When various types of information, such as image information, a sheet conveyance speed, and a sheet type, are input via the operation panel 508, the CPU 501 controls various types of operation of the image forming apparatus 100 based on the input information.

### Configuration of Liquid Discharge Head

Next, a configuration of the liquid discharge head 20 according to the first embodiment will be described.

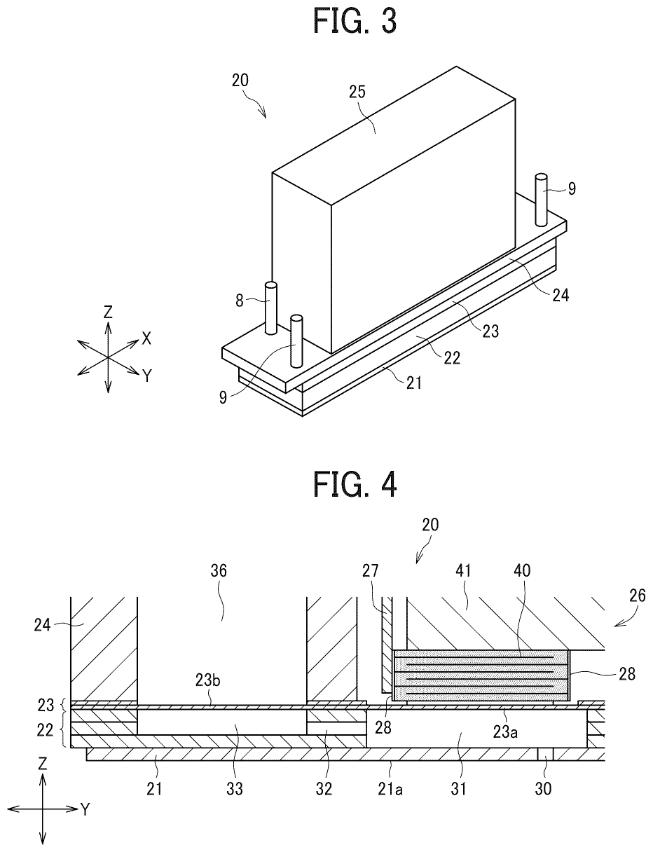

FIG. 3 is an external perspective view of the liquid discharge head 20 according to the first embodiment.

As illustrated in FIG. 3, the liquid discharge head 20 according to the first embodiment is formed in a longitudinal shape elongated in an X direction in the drawing, as a whole. The X direction, the Y direction, and the Z direction in FIG. 3 indicate directions of the three-dimensional coordinate axes of the liquid discharge head 20 according to the first embodiment. In this case, the X direction indicates a direction parallel to a longitudinal direction of the liquid discharge head 20, and the Y direction indicates a direction orthogonal to the X direction when the liquid discharge head 20 is viewed from above in the Z direction. The Z direction is a direction orthogonal to the X direction and the Y direction. The X direction, the Y direction, and the Z direction in the other drawings also indicate the same directions as those in FIG. 3.

As illustrated in FIG. 3, the liquid discharge head 20 according to the first embodiment includes a nozzle plate 21, a liquid chamber member 22, a diaphragm 23, a common channel member 24, a cover member 25, and the like. The nozzle plate 21, the liquid chamber member 22, the diaphragm 23, and the common channel member 24 are laminated (stacked) and joined in this order. The cover member 25 is a member that covers and protects a piezoelectric element (described later) that deforms the diaphragm 23, a drive integrated circuit (IC) that performs drive control of the piezoelectric element, a flexible wiring board that transmits a drive signal to the piezoelectric element, and the like. The common channel member 24 is provided with a supply port 8 for supplying liquid from a circulation device to the liquid discharge head 20 and a collection port 9 for collecting liquid in the liquid discharge head 20 to the circulation device.

FIG. 4 is a cross-sectional view of the liquid discharge head 20 according to the first embodiment taken along the Y direction in FIG. 1.

As illustrated in FIG. 4, the nozzle plate 21 has a surface 21a on which a nozzle 30 opens. Although only one nozzle 30 is illustrated in FIG. 4, multiple nozzles 30 are arranged in the longitudinal direction (X direction in FIG. 3) of the liquid discharge head 20.

The liquid chamber member 22 includes multiple individual chambers 31 individually communicating with the multiple nozzles 30, multiple individual supply channels 32 individually communicating with the multiple individual chambers 31, one or multiple intermediate supply channels 33 communicating with one or multiple individual supply channels 32, and the like.

The common channel member 24 has a common channel 36 (common supply channel) communicating in common with the multiple individual chambers 31. Specifically, the common channel 36 communicates with the multiple intermediate supply channels 33 via a filter portion 23b of the diaphragm 23, and communicates with the multiple individual chambers 31 via the intermediate supply channels 33 and the individual supply channels 32. A supply port 8 (see FIG. 3) communicates with the common channel 36. Thus, when the liquid is supplied from the supply port 8 into the common channel 36, the liquid is supplied from the common channel 36 into the individual chambers 31 through the intermediate supply channels 33 and the individual supply channels 32.

The diaphragm 23 is a deformable member constituting a portion of the wall face of the individual chamber 31. By the diaphragm 23 being joined to the liquid chamber member 22, a groove constituting the individual chamber 31 of the liquid chamber member 22 is sealed by the diaphragm 23, and a vibration region 23a deformable by the diaphragm 23 is formed at the sealed portion. Further, in the vibration region 23a of the diaphragm 23, a piezoelectric actuator 26 as driving means that deforms the diaphragm 23 is provided.

The piezoelectric actuator 26 includes a piezoelectric element 40 and a base 41 that supports the piezoelectric element 40. The piezoelectric element 40 is configured by, for example, piezoelectric layers and internal electrodes being alternately laminated (stacked). The internal electrode is connected to the flexible wiring member 27 via the external electrode 28. As a result, when a drive voltage is applied to the piezoelectric element 40 via the flexible wiring member 27, the piezoelectric element 40 expands and contracts, and the vibration region 23a of the diaphragm 23 is deformed. With the deformation of the vibration region 23a, the liquid in the individual chamber 31 is discharged from the nozzle 30. Specifically, when the vibration region 23a of the diaphragm 23 is pulled upward in FIG. 4 by the contraction of the piezoelectric element 40, the volume of the individual chamber 31 expands, and the liquid flows into the individual chamber 31. Then, due to the extension of the piezoelectric element 40, the vibration region 23a of the diaphragm 23 is pushed downward in FIG. 4, and the volume of the individual chamber 31 is contracted. As a result, the liquid in the individual chamber 31 is pressurized and discharged from the nozzle 30. The liquid that has not been discharged from the nozzle 30 is sent to a collection tank of the circulation device via the collection port 9 (see FIG. 3) and collected. Thereafter, the liquid is sent to a supply tank of the circulation device, and is supplied again from the supply tank to the individual chamber 31 via the supply port 8.

Meanwhile, in the liquid discharge head 20, including the multiple individual chambers 31 as in the first embodiment, there is a problem of crosstalk in which pressure fluctuation in the individual chamber 31 is propagated to the liquid in other individual chambers 31 and affects discharging performance. Thus, the liquid discharge head 20 is provided with a damper that suppresses the propagation of pressure fluctuation.

The larger the width (size) of the damper, the smaller the pressure fluctuation. On the other hand, when the width of the damper is increased, it is necessary to secure an installation space corresponding to the width, and thus, there is a problem that the liquid discharge head increases in size in the width direction. Thus, in the configuration of the liquid discharge head in the comparative example, the width of the damper could not be easily increased. Hereinafter, the problem in a case where the width of the damper is increased will be described by taking the configuration according to a comparative example as an example.

Problem in Case where Width of Damper is Increased

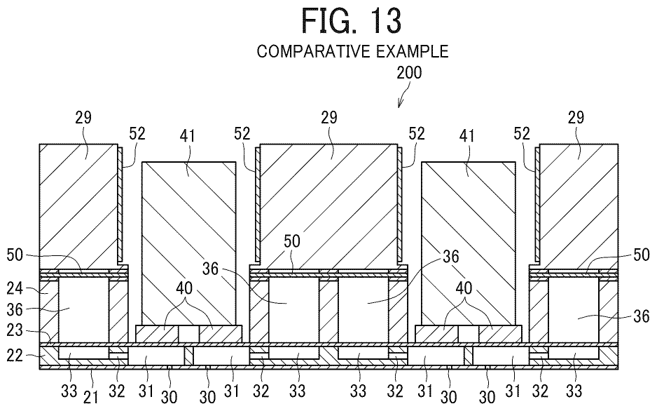

FIG. 13 is a cross-sectional view of a liquid discharge head 200 according to the comparative example.

As illustrated in FIG. 13, in the liquid discharge head 200 according to the comparative example, a sheet-like damper 50 is provided to be sandwiched between the common channel member 24 and a damper frame 29. As a result, a portion of the wall face of the common channel 36 is configured by the deformable damper 50, and thus, a wall face of the common channel 36 can have a damper function. Thus, pressure fluctuation generated in the individual chamber 31 is absorbed by a damper function of the common channel 36 communicating with the individual chamber 31, and propagation of the pressure fluctuation from the individual chamber 31 to another individual chamber 31 is suppressed.

Here, in the liquid discharge head 200 according to the comparative example, the base 41 that supports the piezoelectric element 40 is disposed beside the damper 50, and thus, when the width of the damper 50 is increased in a lateral direction, the damper 50 and the base 41 interfere with each other. Thus, to avoid interference between the damper 50 and the base 41, it is necessary to secure a wide installation space for the damper 50 by, for example, widening the interval between the bases 41, but this causes a problem in that the size of the liquid discharge head 200 increases in the lateral direction.

As described above, in the liquid discharge head 200 according to the comparative example, when the width of the damper 50 is increased, the damper 50 may interfere with the base 41, and when a wide installation space of the damper 50 is secured to avoid the interference, there is a problem that the liquid discharge head 200 increases in size in the width direction.

Thus, in view of the above circumstances, the present embodiment proposes a configuration capable of increasing the width of the damper while avoiding an increase in size of the liquid discharge head. Hereinafter, a characteristic portion of the liquid discharge head according to the present embodiment will be described using the configuration according to the first embodiment as an example.

### Configuration of Characteristic Portion of Liquid Discharge Head

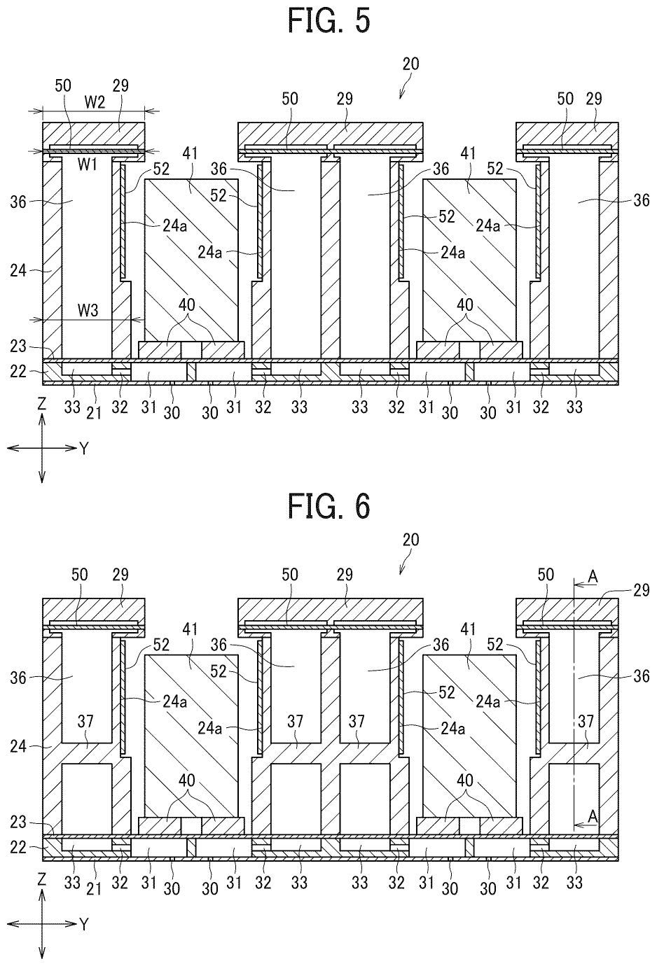

FIG. 5 is a cross-sectional view illustrating a configuration of the characteristic portion of the liquid discharge head 20 according to the first embodiment.

As illustrated in FIG. 5, in the first embodiment, as in the comparative example, the damper 50 constituting a portion of the wall face of the common channel 36 is provided on the side (upper side in FIG. 5) opposite to the nozzle plate 21 side of the common channel member 24. In other words, the damper 50 is disposed on the same side (upper side in FIG. 5) as the base 41 with respect to the nozzle plate 21. However, in the first embodiment, unlike the comparative example, the common channel member 2 is extended to a position higher than the base 41 supporting the piezoelectric element 40, and the damper 50 is provided on the extended distal end side of the common channel member 24. Thus, in the first embodiment, the damper 50 is disposed at a position farther from the nozzle plate 21 than the base 41.

As described above, in the first embodiment, the damper 50 is disposed at a position farther from the nozzle plate 21 than the base 41, and thus, a dimension W1 of the damper 50 in the width direction can be increased when a direction (Y direction in FIG. 5) in which the common channel member 24 and the base 41 are arranged adjacent to each other is defined as the width direction. In other words, even if a dimension W of the damper 50 in the width direction is increased, there is no possibility that the damper 50 interferes with the base 41, so that the size of the damper 50 can be increased to improve the damper function.

Specifically, in the first embodiment, the dimension W1 of the damper 50 in the width direction is larger than the dimension W3 of the common channel member 24 in the width direction. In addition, a dimension W2 in the width direction of the damper frame 29 supporting the damper 50 is also larger than the dimension W3 of the common channel member 24 in the width direction in correspondence with the damper 50. In other words, the damper frame 29 is also arranged on the same side as the base 41 with respect to the nozzle plate 21 similarly to the damper 50, but in the first embodiment, the damper frame 29 is at a position farther from the nozzle plate 21 than the base 41, and thus, the dimension W2 of the damper frame 29 in the width direction can be increased without interfering with the base 41.

In the first embodiment, the common channel member 24 extends to a position higher than the base 41 (to a position farther from the nozzle plate 21 than the base 41), and thus, an installation space for the heater 52 can be secured on the outer face of the common channel member 24. Thus, by disposing the heater 52 on the outer face of the common channel member 24 as illustrated in FIG. 5, heat of the heater 52 is easily transferred to the liquid in the common channel 36 as compared with the case where the heater 52 is disposed on an outer face of the damper frame 29 as in the comparative example (FIG. 13). As a result, in the first embodiment, it is possible to efficiently warm the liquid in the common channel 36 and improve dischargeability.

In the first embodiment, a recess 24a is formed at a location (outer face) where the heater 52 is installed in the common channel member 24, and thus, the step of the recess 24a can be used as a reference for positioning when the heater 52 is installed. This facilitates the positioning of the heater 52, thereby improving the installation workability of the heater 52. In the first embodiment, the dimension W2 of the damper frame 29 in the width direction is larger than the dimension W3 of the common channel member 24 in the width direction, and thus, when the damper frame 29 is joined to the common channel member 24, a step is formed between the common channel member 24 and the damper frame 29. Thus, this step may be used as a reference for positioning the heater 52.

The damper 50 is preferably a sheet-like elastic member made of silicone, or the like. The damper 50 is preferably made of a material that is as thin as possible and has a low Young's modulus. For example, the thickness of the damper 50 is preferably 50 [μm] or more and 500 [μm] or less, and the Young's modulus is preferably 10 [MPa] or less. Note that the damper 50 is not necessarily limited to a sheet-like shape, and may have a shape other than the sheet-like shape.

Next, other embodiments of the present embodiment will be described. In the following description, differences from the first embodiment will be mainly described, and descriptions of the same portions will be omitted as appropriate.

### Second Embodiment

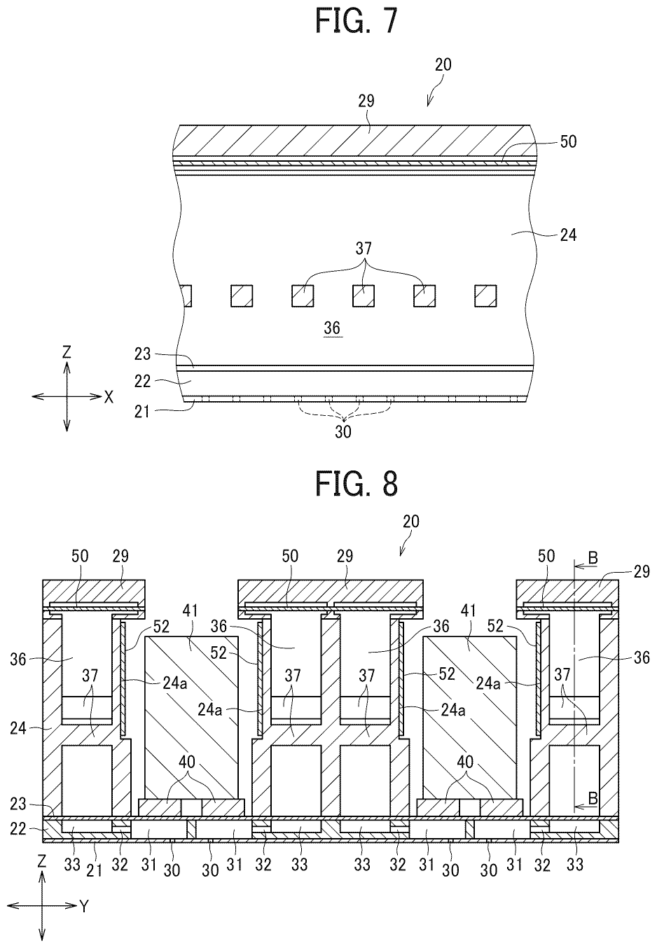

FIG. 6 is a cross-sectional view of the liquid discharge head 20 according to a second embodiment. FIG. 7 is a cross-sectional view of the liquid discharge head 20 according to the second embodiment, taken along a line A-A in FIG. 6.

As illustrated in FIGS. 6 and 7, in the liquid discharge head 20 according to the second embodiment, a columnar reinforcing portion 37 is provided in the common channel 36. The reinforcing portion 37 extends in the width direction (Y direction in FIG. 6) of the common channel 36, and connects the inner faces of the common channel member 24 facing each other.

In the second embodiment, similarly to the first embodiment, the common channel member 24 is extended to a position higher than the base 41, so that the damper 50 is disposed at a position farther from the nozzle plate 21 than the base 41. However, when the common channel member 24 is extended to a position higher than the base 41, there is a concern that the strength of the common channel member 24 may decrease.

Thus, in the second embodiment, the strength of the common channel member 24 is improved by providing the reinforcing portion 37 that connects the inner faces of the common channel member 24 to each other. As a result, vibration due to a decrease in the strength of the common channel member 24 can be suppressed, and a discharge function can be favorably maintained.

As illustrated in FIG. 7, in the second embodiment, multiple reinforcing portions 37 are provided at equal intervals in a nozzle array direction (X direction in FIG. 7) in which the multiple nozzles 30 are arranged, and thus, the strength of the common channel member 24 is improved over the nozzle array direction. However, the number and arrangement of the reinforcing portions 37 are not limited to the aspect illustrated in FIG. 7, and can be changed as appropriate.

### Third Embodiment

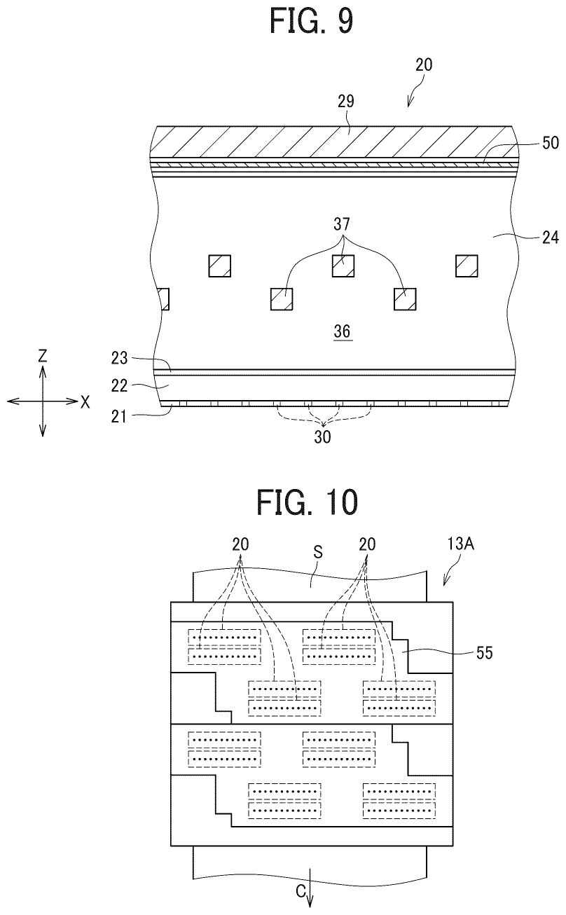

FIG. 8 is a cross-sectional view of the liquid discharge head 20 according to a third embodiment. FIG. 9 is a cross-sectional view of the liquid discharge head 20 according to the third embodiment taken along a line B-B in FIG. 8.

As illustrated in FIGS. 8 and 9, in the liquid discharge head 20 according to the third embodiment, as in the second embodiment, multiple reinforcing portions 37 is provided in the nozzle array direction (X direction in FIG. 9), but the reinforcing portions 37 adjacent to each other are arranged to be shifted from each other in a direction (Z direction in FIG. 9) of approaching or separating from the nozzle plate 21.

As described above, in the third embodiment, the adjacent reinforcing portions 37 are arranged to be shifted from each other in the direction of approaching or separating from the nozzle plate 21, so that it is possible to suppress variations in liquid supply due to the provision of the reinforcing portions 37. In other words, when multiple the reinforcing portions 37 is arranged side by side in the nozzle array direction (see FIG. 7), flow of the liquid in the common channel 36 is hindered by the reinforcing portions 37, and there is a possibility that variations may occur in liquid supply between at a portion where the reinforcing portion 37 is present and at a portion where the reinforcing portion is not present. On the other hand, in the third embodiment, the liquid easily passes between the reinforcing portions 37 by the adjacent reinforcing portions 37 being shifted in the direction of approaching or separating from the nozzle plate 21, so that it is possible to suppress variations in liquid supply due to the provision of the reinforcing portions 37. Thus, according to the configuration according to the third embodiment, it is possible to suppress variations in discharge characteristics for each nozzle 30.

Although each embodiment of the present embodiment has been described above, according to the present embodiment, by disposing the damper 50 at a position farther from the nozzle plate 21 than the base 41, it is possible to increase the width of the damper 50 while avoiding an increase in size of the liquid discharge head 20 in the width direction. According to the present embodiment, the damper function can be improved, and large pressure fluctuation can be suppressed, so that discharging performance can be stabilized.

Furthermore, the liquid discharge head to which the present embodiment is applied may be a so-called line type liquid discharge head that discharges liquid without moving with respect to a sheet to be conveyed, or may be a so-called serial type liquid discharge head that discharges liquid while moving in a direction (sheet width direction) orthogonal to a conveyance direction of a sheet with respect to the sheet. The present embodiment applies to any type of liquid discharge head. Hereinafter, a configuration of a head unit including each type of liquid discharge head will be briefly described.

### Configuration of Line Type Head Unit

FIG. 10 is a plan view illustrating a configuration of a line-type head unit 13A.

The line type head unit 13A illustrated in FIG. 10 includes a head holding member 55 that holds the multiple liquid discharge heads 20. The multiple liquid discharge heads 20 are disposed in a staggered manner as illustrated in FIG. 10, for example. When the sheet S is conveyed in a direction C that an arrow indicates in FIG. 10 and reaches a position facing the head unit 13A, the liquid discharge heads 20 discharge the liquid. In this event, the head unit 13A discharges liquid from the liquid discharge head 20 without moving with respect to the conveyed sheet S. As a result, an image is formed on the sheet S.

### Configuration of Serial Type Head Unit

Next, a configuration of a serial-type head unit will be described.

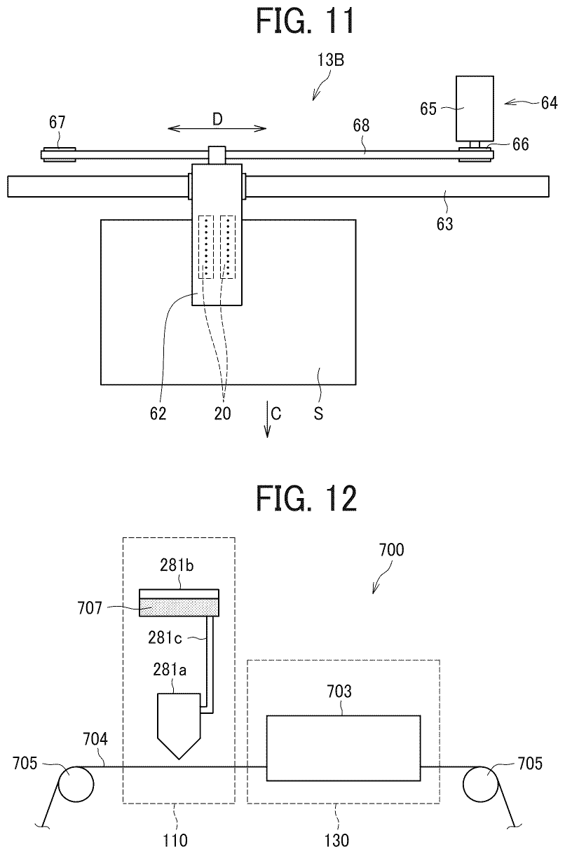

FIG. 11 is a plan view illustrating a configuration of a serial type head unit 13B.

The serial type head unit 13B illustrated in FIG. 11 includes a carriage 62 mounted with the multiple liquid discharge heads 20, a guide member 63 (guide rod) for guiding the carriage 62 in a main scanning direction D that is the sheet width direction (direction orthogonal to the conveying direction C), and a drive device 64 that causes the carriage 62 to move.

The drive device 64 includes, for example, a motor 65 and a timing belt 68. The motor 65 serves as a driving source. The timing belt 68 is looped around a drive pulley 66 and a driven pulley 67. When the motor 65 is driven to rotate the drive pulley 66, the timing belt 68 rotates. As a result, the carriage 62 reciprocates in the main scanning direction D along the guide member 63.

When the sheet S is conveyed in the direction C that the arrow indicates and the sheet S reaches a predetermined image forming position, as illustrated in FIG. 11, the movement of the sheet S is temporarily stopped. While the carriage 62 moves in the main scanning direction D, the liquid discharge heads 20 discharge liquid (ink). As a result, an image corresponding to a predetermined width is formed on the stopped sheet S. Thereafter, intermittent conveyance (conveyance and stop) of the sheet S in the direction C that the arrow indicates and liquid discharge operation accompanying reciprocating movement of the carriage 62 in the main scanning direction D are repeatedly performed, whereby an image is sequentially formed on the sheet S.

The liquid discharge head and the head unit according to the present embodiment may be mounted on an image forming apparatus as an example of the liquid discharge apparatus, or may be mounted on other liquid discharge apparatuses.

For example, the liquid discharge head and the head unit according to the present embodiment may be mounted on an electrode manufacturing apparatus that discharges a liquid composition to manufacture an electrode. Hereinafter, an example of the electrode manufacturing apparatus to which the present embodiment can be applied will be described.

### Configuration of Electrode Manufacturing Apparatus

FIG. 12 is a schematic view illustrating an overall configuration of an electrode manufacturing apparatus 700 to which the present embodiment can be applied.

Here, as an example of the electrode manufacturing apparatus 700, a manufacturing apparatus for forming an electrode mixture layer containing an active material on an electrode substrate (current collector) will be described. The electrode mixture layer is used, for example, as a portion of the configuration of an electrochemical element. The configuration of the electrochemical element other than the electrode mixture layer is not limited to any particular configuration, and a known configuration can be appropriately selected. For example, as a configuration other than the electrode mixture layer, the electrochemical element may include a positive electrode, a negative electrode, and a separator.

The electrode manufacturing apparatus 700 illustrated in FIG. 12 includes a discharging process portion 110 that performs a process of applying a liquid composition for manufacturing an electrode onto a printing base material 704 including a discharge target to form a liquid composition layer, and a heating process portion 130 that performs a heating process of heating the liquid composition layer to acquire an electrode mixture layer.

The electrode manufacturing apparatus 700 includes a conveyor 705 that conveys the printing base material 704. The conveyor 705 conveys the printing base material 704 to the discharging process portion 110 and the heating process portion 130 in this order at a preset speed. A method of manufacturing the printing base material 704 having the discharge target, such as an active material layer, is not limited to any particular method, and a known method can be appropriately selected. The discharging process portion 110 includes a liquid discharge head 281a that implements an application process of applying the liquid composition onto the printing base material 704, a storage container 281b that stores a liquid composition 707, and a supply tube 281c that supplies the liquid composition 707 stored in the storage container 281b to the liquid discharge head 281a.

The discharging process portion 110 discharges the liquid composition 707 from the liquid discharge head 281a so that the liquid composition 707 is applied onto the printing base material 704 to form a liquid composition layer in a thin film shape. The storage container 281b may be integrated with the electrode manufacturing apparatus or may be detachable from the electrode manufacturing apparatus. The storage container 281b may be a container additionally attachable to a container integrated with the electrode manufacturing apparatus or to a container detachable from the electrode manufacturing apparatus.

The storage container 281b and the supply tube 281c can be arbitrarily selected as long as the liquid composition 707 can be stably stored and supplied.

The heating process portion 130 performs a solvent removal process of heating and removing any solvent remaining in the liquid composition layer. Specifically, the solvent remaining in the liquid composition layer is heated and dried by a heating device 703 of the heating process portion 130, and thus, the solvent is removed from the liquid composition layer. Thus, the electrode mixture layer is formed. The solvent removal process in the heating process portion 130 may be performed under reduced pressure.

The heating device 703 is not particularly limited and may be appropriately selected according to the purpose.

For example, the heating device 703 may be a substrate heater, an infrared (IR) heater, a hot air heater, or the like.

The heating device 703 may be a combination of at least two of the substrate heater, the IR heater, and the hot air heater. A heating temperature and heating time can be appropriately selected according to the boiling point of the solvent contained in the liquid composition 707 or the thickness of a formed film.

A target object (discharge target) onto which the liquid composition is discharged is not particularly limited as long as it is an object on which a layer containing an electrode material is formed, and can be appropriately selected according to the purpose. Examples of the target object include an electrode substrate (current collector), an active material layer, and a layer containing a solid electrode material.

The target object may be an electrode mixture layer containing an active material on an electrode substrate (current collector). The discharging means and the discharging process may be means and a process of forming a layer containing an electrode material by directly discharging a liquid composition, as long as the layer containing an electrode material can be formed on the target object (discharge target). The discharging means and the discharging process may be means and a process of forming a layer containing an electrode material by indirectly discharging a liquid composition.

In addition, the present embodiment can be widely applied to a liquid discharge apparatus that discharges liquid to a target object, such as a sheet or an electrode base, and a liquid discharge apparatus that discharges liquid to an object (target object) to which liquid can adhere at least temporarily. Examples of the target object onto which liquid is discharged include a resin film, a wallpaper, and an electronic substrate, in addition to paper. Examples of a material of the target object onto which liquid is discharged include paper, leather, metal, plastic, glass, wood, and ceramics.

In addition, the liquid to be discharged by the liquid discharge apparatus according to the present embodiment is not particularly limited, and includes a solution, a suspension, an emulsion, and the like, containing a solvent such as water or an organic solvent, a colorant such as a dye or a pigment, a function-imparting material such as a polymerizable compound, a resin, or a surfactant, a biocompatible material such as deoxyribonucleic acid (DNA), an amino acid, a protein, or calcium, an edible material such as a natural pigment, and the like. Such a solution, a suspension, or an emulsion can be used for, for example, inkjet ink, a surface treatment solution, liquid for forming components of an electronic element or light-emitting element, a resist pattern of an electronic circuit, or a material solution for three-dimensional fabrication.

A liquid discharge head includes: a nozzle plate having multiple nozzles; a liquid chamber member over the nozzle plate, the liquid chamber member having multiple individual chambers individually communicating with the multiple nozzles of the nozzle plate; a diaphragm over the liquid chamber member, the diaphragm forming a portion of a wall face of the multiple individual chambers; a piezoelectric element over the diaphragm, the piezoelectric element to deform the diaphragm to discharge a liquid in the multiple individual chambers from the multiple nozzles in a discharge direction; a base over the piezoelectric element, the base supporting the piezoelectric element; a common channel member over the diaphragm, the common channel member having a common channel communicating with each of the multiple individual chambers; and a damper over the common channel member, the damper forming a portion of a wall face of the common channel, and the damper is farther from the nozzle plate than the base in the discharge direction.

The common channel member is adjacent to the base in a width direction orthogonal to the discharge direction, the common channel member has a first width in the width direction, and the damper has a second width larger than the first width in the width direction. The liquid discharge head further includes: a damper frame over the common channel member and holding the damper inside the damper frame, and the damper frame is farther from the nozzle plate than the base in the discharge direction.

The damper frame has a third width larger than the first width of the common channel member in the width direction. The damper frame has an outer face protruding from an outer face of the common channel member toward the base in the width direction. The common channel member has: a recess on an outer face facing the base in the width direction; and a heater in the recess. The common channel member includes a reinforcing portion extending in the width direction in the common channel.

The multiple nozzles are arrayed in a nozzle array direction orthogonal to the discharge direction and the width direction, the common channel member includes multiple reinforcing portions including the reinforcing portion, and the multiple reinforcing portions are arrayed in the nozzle array direction. The multiple reinforcing portions adjacent to each other in the nozzle array direction are shifted from each other in the discharge direction.

A head unit includes multiple liquid discharge head including the liquid discharge head. A liquid discharge apparatus includes the liquid discharge head, to discharge liquid onto a target object.

To summarize the aspects of the present embodiment described above, the present embodiment includes at least the following aspects.

### Aspect 1

According to Aspect 1, a liquid discharge head includes: a nozzle plate having multiple nozzles that discharges liquid; a liquid chamber member having multiple individual chambers individually communicating with the multiple nozzles; a diaphragm constituting a portion of a wall face of the multiple individual chambers; a piezoelectric element that is driven to deform the diaphragm; a base that supports the piezoelectric element; a common channel member having a common channel commonly communicating with the multiple individual chambers; and a damper constituting a portion of a wall face of the common channel, the damper being disposed on the same side as the base with respect to the nozzle plate and at a position farther from the nozzle plate than the base.

### Aspect 2

According to Aspect 2, in the liquid discharge head of Aspect 1, when a direction in which the common channel member and the base are arranged adjacent to each other is a width direction, a dimension of the damper in the width direction is larger than a dimension of the common channel member in the width direction.

### Aspect 3

According to Aspect 3, the liquid discharge head of Aspect 1 or Aspect 2 includes a damper frame that is provided on a side of the common channel member opposite to a side of the nozzle plate and supports the damper, in which the damper frame is disposed on the same side as the base with respect to the nozzle plate and at a position farther from the nozzle plate than the base.

### Aspect 4

According to Aspect 4, in the liquid discharge head of Aspect 3, a dimension of the damper frame in the width direction is larger than a dimension of the common channel member in the width direction.

### Aspect 5

According to Aspect 5, in the liquid discharge head of any one of Aspects 1 to 4, the common channel member has a recess on an outer face, and a heater is disposed in the recess.

### Aspect 6

According to Aspect 6, in the liquid discharge head of any one of Aspects 1 to 5, the common channel member includes a reinforcing portion extending in the width direction in the common channel.

### Aspect 7

According to Aspect 7, in the liquid discharge head of Aspect 6, the reinforcing portion includes multiple reinforcing portions, the multiple reinforcing portions is provided in a nozzle array direction in which the multiple nozzles is arranged, and the reinforcing portions adjacent to each other are provided to be shifted from each other in a direction of approaching or separating from the nozzle plate.

### Aspect 8

According to Aspect 8, a head unit includes the liquid discharge head of any one of Aspects 1 to 7, the liquid discharge head including multiple liquid discharge heads.

### Aspect 9

According to Aspect 9, a liquid discharge apparatus discharges liquid onto a target object using the liquid discharge head of any one of Aspects 1 to 7.

1. A liquid discharge head comprising:
a nozzle plate having multiple nozzles;
a liquid chamber member over the nozzle plate,
the liquid chamber member having multiple individual chambers individually communicating with the multiple nozzles of the nozzle plate;
a diaphragm over the liquid chamber member,
the diaphragm forming a portion of a wall face of the multiple individual chambers;
a piezoelectric element over the diaphragm,
the piezoelectric element to deform the diaphragm to discharge a liquid in the multiple individual chambers from the multiple nozzles in a discharge direction;
a base over the piezoelectric element,
the base supporting the piezoelectric element;
a common channel member over the diaphragm,
the common channel member having a common channel communicating with each of the multiple individual chambers; and
a damper over the common channel member,
the damper forming a portion of a wall face of the common channel,
wherein the damper is farther from the nozzle plate than the base in the discharge direction.

2. The liquid discharge head according to claim 1,
wherein the common channel member is adjacent to the base in a width direction orthogonal to the discharge direction,
the common channel member has a first width in the width direction, and
the damper has a second width larger than the first width in the width direction.

3. The liquid discharge head according to claim 2, further comprising:
a damper frame over the common channel member and holding the damper inside the damper frame,
wherein the damper frame is farther from the nozzle plate than the base in the discharge direction.

4. The liquid discharge head according to claim 3,
wherein the damper frame has a third width larger than the first width of the common channel member in the width direction.

5. The liquid discharge head according to claim 4,
wherein the damper frame has an outer face protruding from an outer face of the common channel member toward the base in the width direction.

6. The liquid discharge head according to claim 2,
wherein the common channel member has:
a recess on an outer face facing the base in the width direction; and
a heater in the recess.

7. The liquid discharge head according to claim 2,
wherein the common channel member includes a reinforcing portion extending in the width direction in the common channel.

8. The liquid discharge head according to claim 7,
wherein the multiple nozzles are arrayed in a nozzle array direction orthogonal to the discharge direction and the width direction,
the common channel member includes multiple reinforcing portions including the reinforcing portion, and
the multiple reinforcing portions are arrayed in the nozzle array direction.

9. The liquid discharge head according to claim 8,
wherein the multiple reinforcing portions adjacent to each other in the nozzle array direction are shifted from each other in the discharge direction.

10. A head unit comprising multiple liquid discharge head including the liquid discharge head according to claim 1.

11. A liquid discharge apparatus comprising the liquid discharge head according to claim 1, to discharge liquid onto a target object.
